(19) United States
(12) Patent Application Publication
(10) Pub. No.: US 2024/0047690 A1
(43) Pub. Date: Feb. 8, 2024

(54) LITHIATED METAL ORGANIC FRAMEWORKS WITH A BOUND SOLVENT FOR SECONDARY BATTERY APPLICATIONS

(71) Applicants: ENERGY EXPLORATION TECHNOLOGIES, INC., Austin, TX (US); BOARD OF REGENTS, THE UNIVERSITY OF TEXAS SYSTEM, Austin, TX (US)

(72) Inventors: Richelle LYNDON, Austin, TX (US); Amit PATWARDHAN, Austin, TX (US); Chris AFFOLTER, Austin, TX (US); Karl P. LILLERUD, Austin, TX (US); Teague EGAN, Austin, TX (US); Nicholas Spencer GRUNDISH, Austin, TX (US); Kevin Kruschka REIMUND, Austin, TX (US); Benny Dean FREEMAN, Austin, TX (US); John Bannister GOODENOUGH, Austin, TX (US)

(73) Assignees: ENERGY EXPLORATION TECHNOLOGIES, INC., Austin, TX (US); BOARD OF REGENTS, THE UNIVERSITY OF TEXAS SYSTEM, Austin, TX (US)

(21) Appl. No.: 18/264,457

(22) PCT Filed: Feb. 10, 2022
(86) PCT No.: PCT/US2022/015996

§ 371 Date: Aug. 7, 2023

Related U.S. Application Data
(60) Provisional application No. 63/148,037, filed on Feb. 10, 2021.

(51) Int. Cl. H01M 4/62; H01M 10/056

(52) U.S. Cl. CPC H01M 4/628; H01M 10/056; H01M 2300/0065

(57) ABSTRACT

Lithiated metal organic frameworks, methods of manufacturing lithiated metal organic frameworks, for example, by binding a solvent molecule to the MOF structure to achieve a highly lithiated bound solvent metal organic framework having improved Li+-ion conductivity, and applications for use of the lithiated metal organic frameworks, for example, in various capacities in rechargeable lithium batteries.

This application claims the benefit of priority to U.S. Provisional Application No. 63/148,037, filed on Feb. 10, 2021, the entire contends of which are hereby incorporated by reference.

### BACKGROUND

Lithium-ion batteries have become an essential component of modern society, allowing for many devices to become wireless and portable. The maturing of lithium-ion batteries has led to the development and commercialization of electric (EVs) and hybrid electric vehicles (HEVs). A typical commercial lithium-ion battery includes an insertion cathode containing lithium, an insertion anode which can reversibly store lithium within its structure, a polymer separator that serves to physically keep the two electrodes from contacting, and a liquid electrolyte responsible for Li+-ion transport between the two electrodes during operation. Although this battery has afforded tremendous technological advancements since its initial commercial introduction in 1991, there remain pitfalls that hinder its practicality and safety under certain conditions.

A rechargeable battery is assembled in the discharged state. During the operational cycle, the working cations flow between the active materials of the anode and cathode. When the battery is charging, the cations flow from the cathode, through the electrode and to the anode. When the battery is discharging, the cations flow from the anode to the cathode through a liquid electrolyte. In each instance, the flow of positive charges carried by the cations is compensated by electrons that traverse an external circuit. Current cathode materials used for lithium ion batteries are generally lithium containing materials with a layered crystalline structure in which lithium is housed in the Van der Waals gap between MO2 layers (where M is a single transition metal or a combination of transition and non-transition metals). Common anode materials include graphitic carbon and silicon. Lithium can insert itself into graphite, while silicon alloys with lithium. The liquid electrolyte is generally composed of an organic solvent with a lithium conducting salt, for example, LiPF₆. A porous polymer separator is used to provide physical separation between the cathode and anode while allowing the liquid electrolyte to conduct ions between the two electrodes.

An all-solid-state battery typically functions on the same fundamental principles as a traditional lithium ion battery with the exception that the polymer separator and liquid electrolyte components are replaced with a solid-state electrolyte. This replacement allows for several advantages over traditional lithium batteries. Traditional liquid electrolytes are composed of flammable organic solvents, which present a safety hazard. Solid-state batteries are a safer alternative with potential to have a higher energy density than traditional lithium-ion batteries by replacing the organic solvent liquid electrolyte with a solid electrolyte. Solid-state electrolytes are non-flammable, negating this concern. Additionally, solid-state electrolytes can be stable against a lithium metal anode, which has a much higher capacity than traditional graphite anodes (for example, 3860 mAh g⁻¹ versus 372 mAh g⁻¹). Transition to a lithium metal anode, that can be formed in-situ during the first cycle (formation cycle) of the battery or placed during assembly, allows for a much greater volumetric and gravimetric energy density of the battery. Further, if a solid electrolyte is mechanically robust enough to block dendrite nucleation or permeation through the battery, the battery can be charged and discharged much faster than traditional batteries, which much be carefully monitored so as to not provoke dendrite formation. If a metallic dendrite is formed and grows across the cell from the anode to make contact to the cathode, an electrical short circuiting of the cell occurs and causes an event known as thermal runaway, where the temperature of the battery increases uncontrollably. When this event occurs, the flammable liquid electrolyte can combust.

Most solid-state lithium-ion conductors being pursued for all-solid-state battery applications are crystalline ceramics. Certain classes of crystalline solids have the level of lithium-ion conductivity necessary to allow for solid-state batteries that are competitive with current state-of-the-art lithium-ion batteries. However, all of these materials require difficult synthesis procedures and are moisture sensitive. Additionally, the solid-solid electrode-electrolyte interface is not mechanically robust to allow for long-term cycling of all-solid-state batteries with these materials serving as the electrolyte. Metal organic frameworks (MOFs) are a unique class of crystalline solids that are not conductive of lithium ions unless they are lithiated.

There has been relatively little work performed on lithiating MOFs to function in secondary batteries. Table 1 summarizes the known work on lithiating MOFs and the measured ionic conductivities resulting from these attempts. None of the reports attempted to quantify the amount of lithium uptake by the MOF or the amount of lithium in the final material. These materials fall short for any practical applications in terms of ionic conductivity. Another method to improve the ionic conductivity of highly porous MOF materials is to bind a solvent and conducting salt by immersing the MOFs in a liquid electrolyte solution.

TABLE 1
Ionic conductivities of lithiated metal organic frameworks reported
in literature. Ionic conductivities determined through analysis
of electrochemical impedance spectroscopy. Ionic conductivities
determined at room-temperature unless otherwise noted in parenthesis.

| | | | Ionic |
|---|---|---|---|
| | Metal Organic | | Conductivity |
| Author | Framework | Salt | (S/cm) |
| Ameloot et al. | UIO-66 | LiOtBu | 1.8 × 10⁻⁵ |
| Ameloot et al. | UIO-66 deprotonated | LiOtBu | 3.3 × 10⁻⁶ |
| Park et al. | MIT-20 | LiCl—THF | 1.3 × 10⁻⁵ |
| Park et al. | MIT-20 | LiBr—THF | 4.4 × 10⁻⁵ |
| Baumann et al | UIO-66 | LiNO₃—DMF | 1.02 × 10⁻⁸ |
| Baumann et al. | UIO-66 (50Benz) | LiNO₃—DMF | 1.2 × 10⁻⁸ |
| Baumann et al. | UIO-66 (12TFA) | LiNO₃—DMF | 1.07 × 10⁻⁸ |

Table 2 summarizes the battery systems reported in literature and their resulting ionic conductivities. Only one system demonstrated ionic conductivity above the 1×10⁻³ S cm⁻¹ mark deemed necessary for consideration in commercial secondary batteries.

TABLE 2
Ionic conductivities of bound-solvent metal organic frameworks reported
in literature. Ionic conductivities determined through analysis of
electrochemical impedance spectroscopy. Ionic conductivities determined
at room-temperature unless otherwise noted in parenthesis.

| | Metal | | | Ionic |
|---|---|---|---|---|
| | Organic | | | Conductivity |
| Authors | Framework | Solvent | Salt | (S/cm) |
| Wiers et al. | Mg2(dobdc) | EC/DEC | LiBF₄ | 1.8 × 10⁻⁶ |
| Wiers et al. | Mg2(dobdc) | EC/DEC | LiOⁱPr | 1.2 × 10⁻⁵ |
| Wiers et al. | Mg2(dobdc) | EC/DEC | LiOⁱPr + | 3.1 × 10⁻⁴ |
| | | | LiBF₄ | |
| Chen et al. | ZIF-67 | ([Py13][TFSI]) | LiTFSI | 2.29 × 10⁻³ |
| | | | | (30° C.) |
| Park et al. | MIT-20 - LiBr | PC | LiBF₄ | 4.8 × 10⁻⁴ |
| Shen et al. | MOF-5 | PC | LiClO₄ | 1.3 × 10⁻⁴ |
| Shen et al. | UIO-67 | PC | LiClO₄ | 6.5 × 10⁻⁴ |
| Shen et al. | UIO-66 | PC | LiClO₄ | 1.8 × 10⁻⁴ |
| Shen et al. | MIL-100-Al | PC | LiClO₄ | 1.22 × 10⁻³ |
| Shen et al. | MIL-100-Cr | PC | LiClO₄ | 2.3 × 10⁻⁴ |
| Shen et al. | MIL-100-Fe | PC | LiClO₄ | 9.0 × 10⁻⁴ |

A single report referred to a combined lithiation and bound solvent approach to improving the ionic conductivity of MOFs. The parameters of this material are provided in Table 3. This material had a very low lithiation level and used the final MOF material as a cathode additive in a lithium-sulfur battery with a liquid electrolyte to enhance the utilization of the active sulfur material in the cathode during cycling. To date, there has not been any report of a lithiated MOF with a bound solvent serving as a solid-state electrolyte for an all-solid-state secondary battery.

TABLE 3
Ionic conductivities of bound-solvent lithiated metal organic
frameworks reported in literature. Ionic conductivities
determined through analysis of electrochemical impedance
spectroscopy. Ionic conductivities determined at room-
temperature unless otherwise noted in parenthesis.

| | Metal | Lithiation | | | Ionic |
|---|---|---|---|---|---|
| | Organic | Level | | | Conductivity |
| Authors | Framework | (Li/Zr₆) | Solvent | Salt | (S/cm) |
| Liu et | 2,6-Zr-AQ | 1.19 | DME/ | LiTFSI + | 4.8 × 10⁻⁷ |
| al. | | | DOL | 2% LiNO₃ | |

Similarly, there have been few studies on methods for lithiating MOFs efficiently and effectively. The methods typically treat the MOF with a lithium salt dissolved in a non-protic organic solvent, for example, dimythylformamide (DMF), often with an organic base added. An alternative treatment with lithium alkoxide has also been described. An alternative LiNO₃ impregnation method can also be found in the literature, which allowed for a Li:Zr loading of 3.8%. However, these methods are time consuming and/or result in insufficient lithiation levels for commercial use.

### SUMMARY OF THE DISCLOSURE

Herein described are methods for lithium loading of MOF materials that are simpler, faster and provide significantly higher lithium loading compared to previous methods. The resulting lithiated MOF materials have fast Li⁺-ion conductivity and can serve in various capacities, for example, in rechargeable lithium batteries. The bound solvent MOFs described herein have exceptionally high levels of lithiation and provide significantly enhanced levels of Li⁺-ion conductivity. For example, the lithiated MOFs can have a conductivity of from 1×10⁻⁸ to 0.05 S/cm as measured by electrochemical impedance spectroscopy. In another embodiment, the lithium conductivity of such MOFs is from 1×10⁻⁶ to 0.01 S/cm, or from 1×10⁻⁴ to 0.005 S/cm, although other conductivities may also be achieved using the teachings herein.

In one embodiment, the present disclosure provides a composition including a metal organic framework structure comprising defect sites containing one of lithium, sodium, or potassium, wherein the respective degree of lithiation, sodiation, or potassiation is, for example, from 1 to 50, from 3 to 25, from 20 to 25, or from 22 to 24. In another embodiment the degree of lithiation is from 2 to 7, or from 4 to 6. Other ranges also are suitable given the teachings herein. The “degree” of lithiation, sodiation, or potassiation numbers provided are in terms of lithium, sodium, or potassium ions per formula unit of MOF. The metal organic framework can include, for example, a Zr-metal organic framework structure and/or a non-Zr metal organic framework structure. In one embodiment, the defect sites include lithium and the composition has a degree of lithiation from 1 to 50.

In another embodiment, the present disclosure provides a composition including a metal organic framework structure comprising defect sites and open structural sites comprising lithium ions and absorbed solvent molecules, wherein the degree of lithiation is from 1 to 50, from 3 to 25, from 20 to 25, from 22 to 24, from 2 to 7, from 2 to 6, or other suitable degrees as discussed herein above.

In another embodiment, the present disclosure provides methods of lithiating a metal organic framework structure which can include providing a lithiation buffer comprising a lithium containing compound and a buffer; contacting a metal organic framework structure with the lithiation buffer to lithiate the metal organic framework structure; separating and washing the lithitated metal organic framework structure to remove residual lithium; and drying the lithiated metal organic framework. The pH of the litiation buffer can be maintained from, for example, 7 to 10, or 8 to 9. The pH of the lithiation buffer can be adjusted prior to contacting the lithiation buffer and the metal organic framework. The lithiation buffer can include one of boric acid and phosphoric acid. A second lithium containing compound can be added to the lithiation buffer prior to contacting the lithiation buffer and the metal organic framework. The second lithium containing compound can be the same lithium containing compound as the first lithium containing compound. The metal organic framework structure can include a Zr-metal organic framework structure and/or a non-Zr-metal organic framework structure. The metal organic framework structure can be UiO-66-(COOH)2. The lithiation solution can include at least ten times more lithium than a theoretical maximum number of adsorption sites in the metal organic framework structure. The lithiation buffer can have a concentration of lithium, for example, from 1×10⁻⁶ M to 10 M (mols/liter), from 0.001M to 5M, or from 0.1M to 2M. This can be determined, for example, by atomic emission spectroscopy.

In another embodiment, the above described lithiated metal organic framework composition can be included in a battery having a cathode and an anode. The lithiated metal organic framework can function as a solid electrolyte, a buffer layer between the cathode and/or anode, or as an additive to the cathode and/or anode.

In yet another embodiment, the above described solvent bound lithiated metal organic framework composition can be included in a battery. The solvent bound lithiated metal organic framework can function as a solid electrolyte, a buffer layer between the cathode and anode, and/or as an additive to one of the cathode and/or anode. In addition to enhancing the ionic conductivity of the MOFs, the bound solvent allows the MOF to have a solid-liquid like interface between the electrode and electrolyte, which is advantageous for long-term cycling of all-solid-state batteries.

### BRIEF DESCRIPTION OF THE DRAWINGS

FIG. 1 depicts MOFs with charge compensating groups on the metal cluster.

FIG. 2 shows the Density Functional Theory (DFT) optimized structure of UiO-66-(COOH), with two Lithium ions and a Propylene Carbonate-molecule absorbed inside the structure.

FIG. 3 shows thermogravimetric and differential scanning calorimetry results from UiO-66-(COOH)₂ samples before and after treatment in Propylene Carbonate.

FIG. 4 shows thermogravimetric and differential scanning calorimetry results from UiO-66 samples before and after treatment in Propylene Carbonate.

FIG. 5 is an example of base MOF powder sample after pressure cell disassembly following electrochemical impedance spectroscopy measurement.

FIG. 6 shows electrochemical impedance spectrum of UiO-66-BDC-(COOH)₂-pH7 MOF sample shown in FIG. 5 with a lithiation level of 5 (Li:Zr₆).

FIG. 7 is an image of pellet of bound solvent UiO-66-BDC-(COOH)₂-pH7 used for electrochemical impedance spectroscopy.

FIG. 8 is electrochemical impedance spectrum of bound solvent UiO-66-BDC-(COOH)₂-pH7 MOF pellet shown in FIG. 7.

FIG. 9 is an image of pellet of bound solvent UiO-66-BDC-(COOH)₂-pH7 used for electrochemical impedance spectroscopy.

FIG. 10 is an electrochemical impedance spectrum of UiO-66-BDC-(COOH)₂-pH7 MOF pellet shown in FIG. 9.

FIG. 11 depicts an equivalent circuit used to interpret electrochemical impedance spectra to obtained R₂. R₂ was then used as sample resistance (Rₛ) in eq. (1) to determine the ionic conductivity of the sample.

FIG. 12 is an illustration of the three different sites that are available for exchange with charged ions. The LiOH titration curve with its derivative reveals at what pH conditions the different sites are exchanged.

FIG. 13 are titration curves produced during an MOF lithiation process. The x-axis refers to the volume of buffer solution added. The y-axis shows the corresponding pH value of the solution.

FIG. 14 shows Lithiation results from the experiment summarized in FIG. 13 for the UIO-66-(COOH)₂ MOF. Lithiation level for the MOF at each pH was measure with atomic emission spectroscopy.

FIG. 15 is lithiation results from the experiment summarized in FIG. 13 for the UiO-66-BDC MOF. Lithiation level for the MOF at each pH was measure with atomic emission spectroscopy.

FIG. 16 shows powder X-ray diffraction data showing the integrity of the crystalline lattice of UiO-66-(COOH)₂ after MOF lithiation to varying pH levels.

FIG. 17 shows powder X-ray diffraction data showing the integrity of the crystalline lattice of UiO-66 after MOF lithiation to varying pH levels.

FIG. 18 shows thermo-gravimetric measurements on highest lithiated UiO-(COOH), and the UiO-(COOH), before lithiation.

FIG. 19 is a schematic of a solid-state secondary battery.

FIG. 20 is a schematic of a solid-state lithium metal symmetric cell.

FIG. 21 shows galvanostatic cycling curves of an all-solid-state lithium metal symmetric cell with a lithiated bound solvent MOF solid-state electrolyte.

FIG. 22 is a schematic of a secondary battery.

FIG. 23 is a schematic of a secondary battery.

FIG. 24 depicts a pressure cell used to conduct electrochemical impedance spectroscopy measurements on base MOF powders. Base MOF powders had various levels of lithiation but did not have a bound solvent added.

### DETAILED DESCRIPTION

### A. Highly Lithiated Metal Organic Frameworks

Metal organic frameworks (MOF) are a class of compounds that have metal ions coordinated to organic ligands to form multi-dimensional structures. During production of MOFs, defect sites occur. The defects can contain potential voids and/or defects. These voids and/or defects can be functionalized with ions, for example, of lithium, potassium, and/or sodium ions to form, e.g., lithiated, MOFs.

After the lithiation process, as described in further detail below, the lithiated MOFs can have a conductivity of, for example, from 1×10⁻⁸ to 0.05 S/cm as measured by Electrochemical Impedance Spectroscopy. The lithiated MOFs can have a level of lithiation from 1 to 50, from 3 to 25, from 20 to 25, from 22 to 24, from 2 to 7, from 2 to 6, or other suitable degrees of lithiation as discussed herein above. In the case of UIO-66, it also can be referred to as the Li/Zr₆ since there is one Zr₆ cluster per formula unit of MOF.

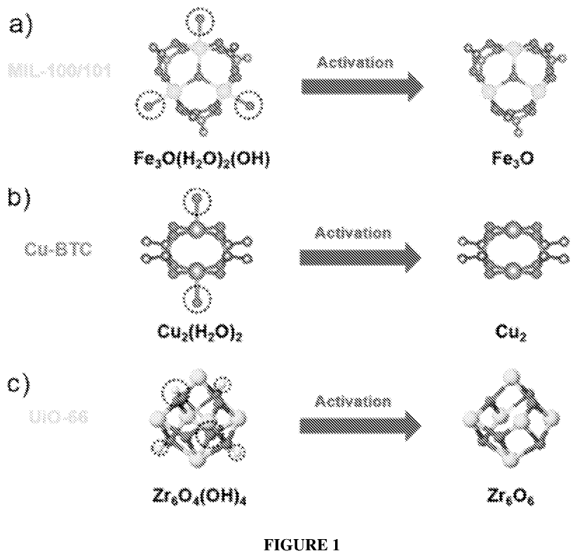

The present disclosure is generally applicable to all classes of MOFs. In particular, the present disclosure is applicable to MOFs in which protons can be removed and/or substituted without destroying the crystalline atomic structure. Such MOFs include, for example, UiO-66 (Zr₆O₄(OH)₄), MIL-101/100 (Fe₃O(H₂O)₂(OH)), Cu-BTC (or HCUST-1) (Cu₂(H₂O)₂), as shown in FIG. 1. FIG. 1 shows MOFs with charge compensating groups on the metal cluster. The Zr₆O₄(OH)₄ cluster in the UiO-type MOFs have four exchangeable OH⁻ on each cluster. These four exchangeable OH⁻ sites are locations where lithium substitution can occur.

The requirement for charge neutrality and available space will regulate the maximum theoretical amount of lithium that can be inserted into the MOF structure. The metal ions within these structures are positively charged. To load a metal ion, such as Li⁺, into the structure another positively charged species is removed to maintain charge balance. The primary candidate for charged species to be removed in MOFs are protons (H⁺). Some MOFs have protons on the metal cluster that can be removed without degradation to the underlying crystalline structure framework of the material. By way of illustration only, some MOFs in which protons can be removed without destroying the crystalline atomic structure include, but are not limited to, UiO-66 (Zr₆O₄(OH)₄), MIL-101/100 (Fe₃O(H₂O)₂(OH)), Cu-BTC (or HCUST-1) (Cu₂(H₂O)₂). Exchangeable protons may also be present in the linkers within the MOF structure, such as COOH groups, ═OH groups, or SO₃H₂ groups. In the UiO-66 type structures there are six linkers per cluster, one linker per Zr atom in the cluster. When UiO-66 is made with BDC-(COOH)₂ linkers there will be two exchangeable protons per Zr or 12 per Zr₆-cluster. Thus, when considering the 12 exchangeable protons in the linker protons and the 4 from cluster protons, a total of 16 protons in the UiO-66-(COOH)₂ MOF can be replaced with Li⁺ per unit cell in accordance with this mechanism. If more lithium ions are loaded into the structure, these additional ions are accompanied by anions to maintain overall charge neutrality. For example, if lithium perchlorate is used as a lithium source to lithiate UiO-66-(COOH)₂ beyond the 16 Li⁺/Zr₆-cluster, each additional Li⁺-ion may be accompanied by a ClO₄⁻ anion into the internal pore space of the MOF structure. As used herein, the theoretical limit of loading is the number of exchangeable protons in the MOFs.

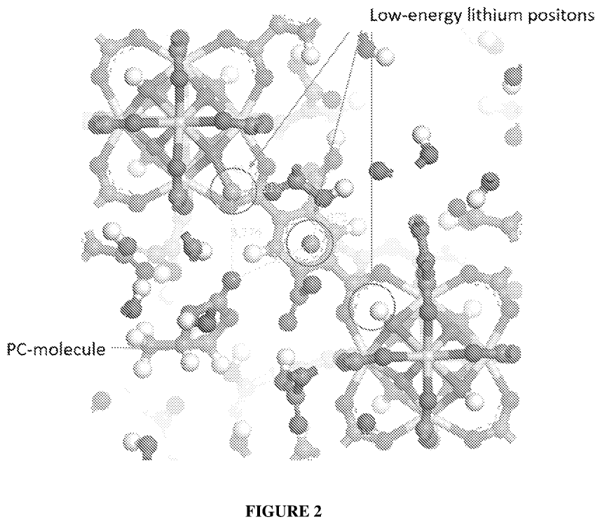

FIG. 2 illustrates that interaction between the COOH groups on the linkers and m-OH groups on the Zr₆-cluster together form coordination stabilized low energy positions for Li⁺-ions that are only 4 ångstrøms apart, creating pathways for high conduction via jumping of lithium ions. The Density Functional Theory (DFT) optimized structure of UiO-66(COOH)₂ with two lithium ions and a propylene carbonate (PC) molecule absorbed inside the structure. The addition of a PC molecule is discussed in further detail below in the Bound Solvent portion of this disclosure.

A propylene carbonate (PC) molecule is too bulky to have the freedom to move close enough to the lithium ions to be within their coordination sphere. However, the PC molecule may stabilize the transition state when Li⁺-ions jump between each stable location.

The present disclosure is not limited to lithiated MOFs. Indeed, the present disclosure is applicable to MOFs having additional sodium, e.g., sodiated MOFs, and MOFs having additional potassium, e.g., potassiated MOFs.

### B. Bound Solvent in Lithiated MOFs

Lithiated MOFs can be further modified through the inclusion of solvent into the MOF structure. The inclusion of solvent in the MOF structure can result in improved ionic conductivity. Methods of binding the solvent to the lithium ion are described below.

The amount of solvent that can be bound to a lithiated MOF varies based upon the type of solvent. Solvents that can be bound in lithitated MOFs include, for example, propylene carbonate, dimethyl carbonate, diethyl carbonate, and fluoroethylene carbonate. In particular, it has been found that propylene carbonate (PC) is particularly useful. For PC, the amount of solvent that can be included ranges, for example, from 1 to 50 in terms of PC molecules per formula unit of MOF.

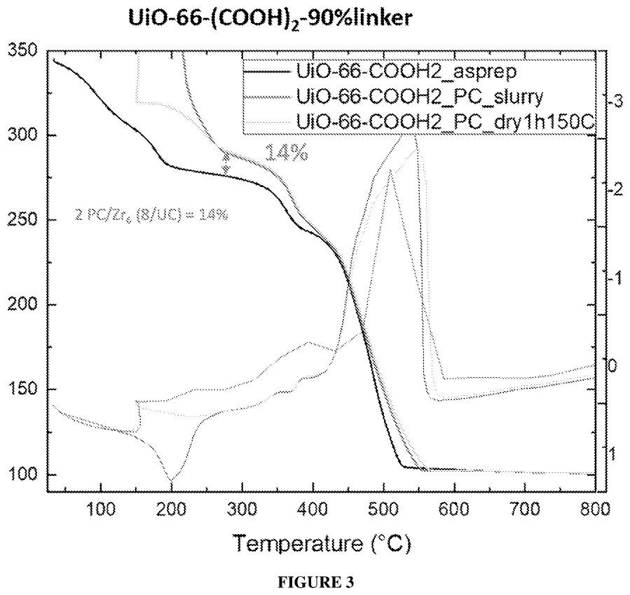

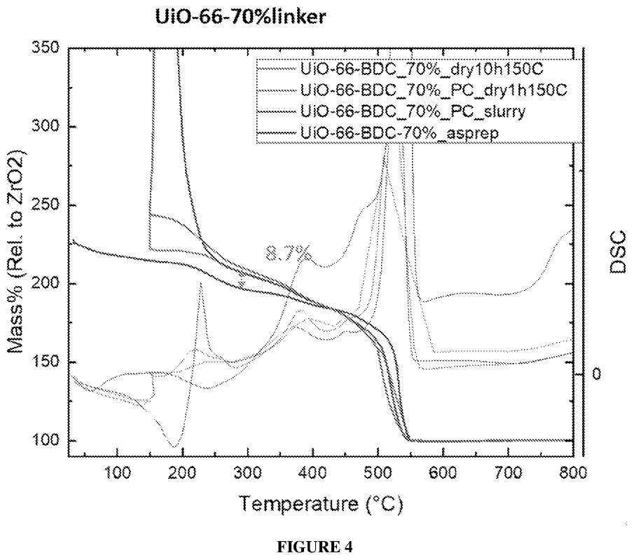

Thermo-gravimetric measurements are a direct method for quantifying absorption of solvent in microporous materials. FIGS. 3 and 4 show this measurement for UiO-66 and UiO-66-(COOH)₂ MOFs, respectively, before and after soaking in propylene carbonate (PC).

To determine the amount of solvent that is adsorbed inside these microporous materials, it is important to remove all the excess physiosorbed solvent. Therefore, materials that are wet with solvent and materials dried at 150° C. for various times are compared. For example, an adsorbed solvent can be propylene carbonate. The boiling point of PC is 242° C. Above this temperature are the traces from “wet” samples overlapping. The additional weight from PC is measured and compared at 300° C. For UiO-66 samples, this accounts for 8.7% weight loss, which is equivalent to one PC molecule per Zr₆-cluster or four PC molecules per unit cell; in the UiO-66-(COOH)₂ material, the absorption is nearly two times this value—14% weight loss or 8 PC molecules per unit cell. This result is unexpected because there is much less space available in the UiO-66-(COOH)₂ structure for PC molecules to reside in relative to the base UiO-66 structure. The extra —COOH groups on the linkers occupy most of the internal space in UiO-66-(COOH)₂, but the ═O, —OH or —O on the functionalized linkers will carry a negative charge, which might cause the highly polar PC molecules to organize and therefore fit in between the bulky BDC-(COOH)₂ linkers. There is one large octahedral cage and two smaller tetrahedral cages per Zr₆ cluster in the UiO-66 type structures. Therefore, filling one PC molecule per Zr₆ will result in one molecule in each octahedral cage; additional filling with PC typically would require that the smaller tetrahedral cages are also filled.

C. Lithiation and Bound Solvent effect on Ionic Conductivity

The lithiation and bound solvent can have a substantial effect on the ionic conductivity of the MOF. To illustrate, three different MOFs with varying levels of lithiation were tested to determine the effect of lithiation on ionic conductivity. The lithiation levels were chosen to cover a spread to determine the optimal Li:Zr₆ ratio for ionic conductivity. A non-lithiated sample was also subjected to the sample solvent binding processes as a control. As MOFs can rarely be synthesized defect-free, the lithium ions added during the lithiation process and the bound solvent/lithium salt molecules from the electrolyte occupy these defect sites. Thus, maintaining a control sample in which all of the defect sites are occupied by solvent molecules allows for the comparison over which factor aids ionic conduction more, lithiating the MOF, or adding bound solvent/lithium salt molecules into the structure. Table 4 summarizes the different MOFs used and the levels of lithiation for each MOF. Each of these MOFs were also subjected to various levels of soaking to evaluate the effect of electrolyte to MOF ratio during soaking on the ionic conductivity of the lithiated bound solvent MOF samples. The three levels of electrolyte used for soaking during the experiments were no solvent, moderate solvent (10:1) [mL:g], and heavy solvent (20:1) [mL:g]. Each sample was tested multiple times. Table 5 summarizes the results of all impedance measurements performed accounting for standard error.

TABLE 4
Summary of metal organic framework samples and their degree of lithiation.

| Degree of | UIO-66-BDC- | UIO-66-BDC- | UIO-66-BDC- | UIO-66-BDC- |
|---|---|---|---|---|
| Lithiation | (COOH)₂ | (COOH)₂— pH 7 | (COOH)₂—Li₂SO₄-2 | (COOH)₂—Li₂SO₄-5 |
| Li:Zr₆ ratio | N/A | 5 | 23.1 | 17.4 |

TABLE 5
Summary of ionic conductivity values obtained from equivalent circuit analysis of all trials of electrochemical
impedance spectroscopy measurements of bound-solvent metal-organic frameworks with various levels
of lithiation prepared with different amounts of solvent. Standard error provided.

| | UIO-66- | UIO-66-BDC- | | | |
|---|---|---|---|---|---|
| | BDC- | (COOH)₂— | UIO-66-BDC- | UIO-66-BDC- | UIO-66-BDC- |
| Solvent | (COOH)₂ | pH 7 | (COOH)₂—Li₂SO₄- | (COOH)₂—Li₂SO₄- | (COOH)₂—Li₂SO₄- |
| Amount | (3 trials) | (3 trials) | 2 (1 trial) | 5 (2 Trials) | 5_Coarse (1 trial) |
| No | N/A | 3.11 × 10⁻⁹ ± | 2.49 × 10⁻¹⁰ | 5.86 × 10⁻¹⁰ ± | N/A |
| Solvent | | 7.2 × 10⁻¹² | S/cm | 2.39 × 10⁻¹⁰ | |
| | | S/cm | | S/cm | |
| Moderate | 7.53 × 10⁻⁵ ± | 3.09 × 10⁻⁴ ± | 5.02 × 10⁻⁴ | 4.21 × 10⁻⁵ ± | 9.25 × 10⁻⁶ |
| Solvent | 4.28 × 10⁻⁵ | 2.17 × 10⁻⁴ | S/cm | 1.63 × 10⁻⁵ | S/cm |
| mL:g | S/cm | S/cm | | S/cm | |
| [10:1] | | | | | |
| High | 2.91 × 10⁻⁴ ± | 1.55 × 10⁻³ ± | 1.4 × 10⁻³ | 4.48 × 10⁻⁵ ± | 6.01 × 10⁻⁶ |
| Solvent | 2.01 × 10⁻⁴ | 1.2 × 10⁻⁴ | S/cm | 2.35 × 10⁻⁵ | S/cm |
| mL:g | S/cm | S/cm | | S/cm | |
| [20:1] | | | | | |

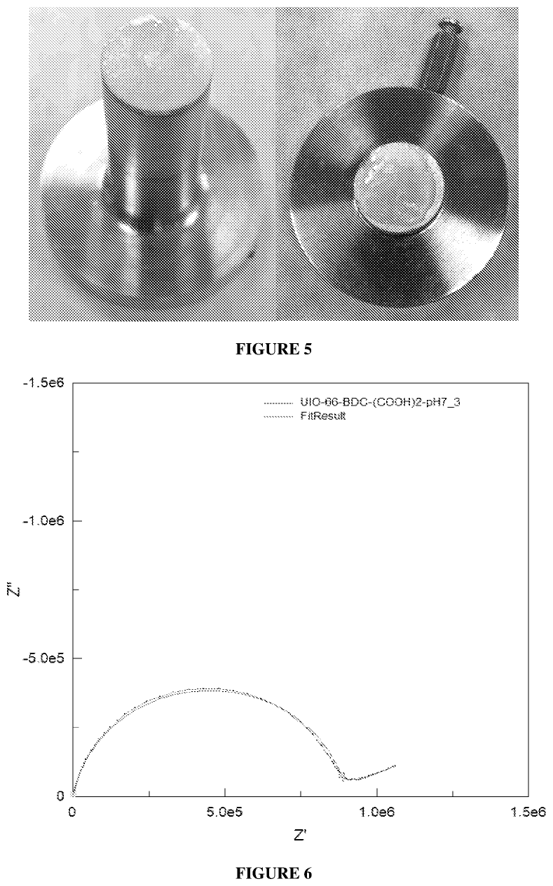

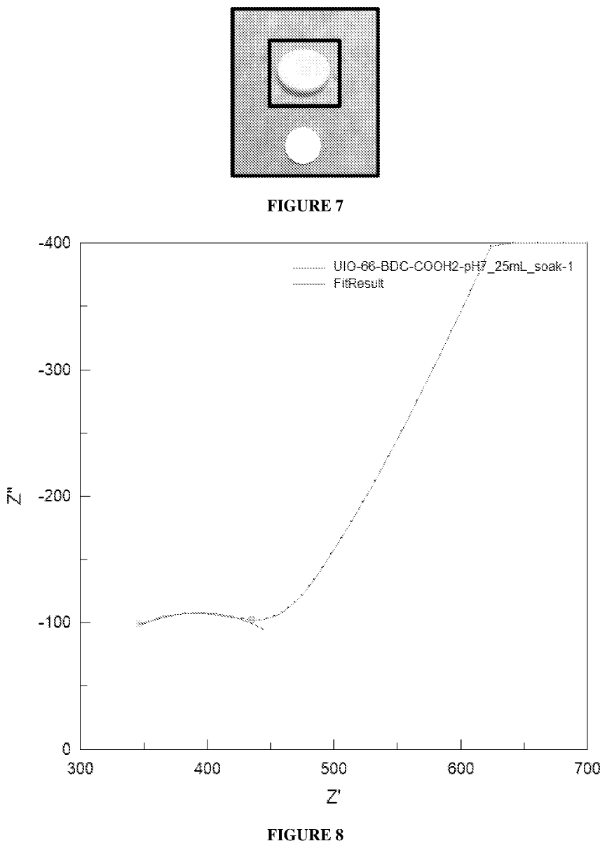

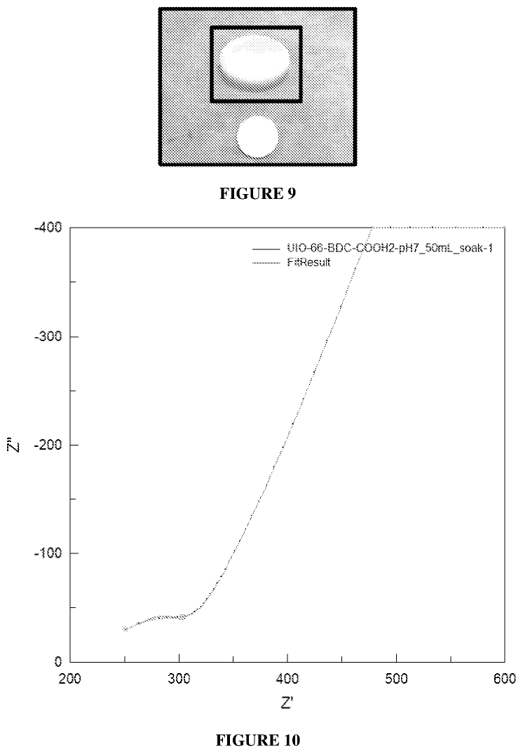

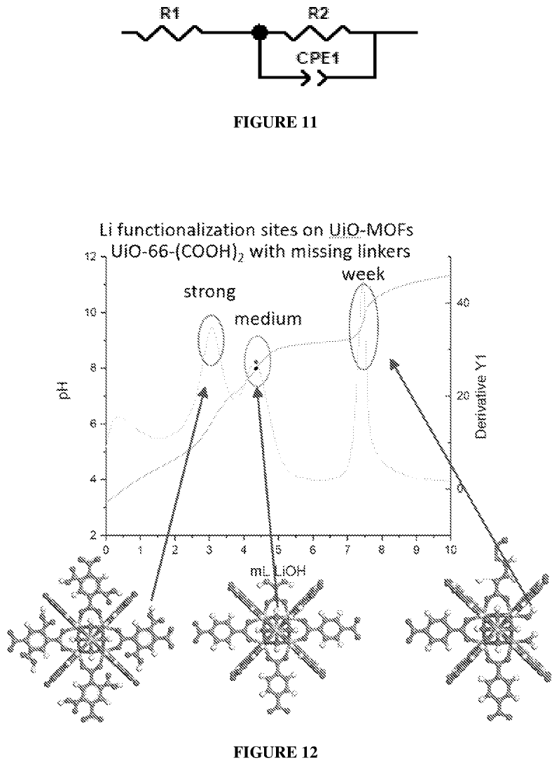

At each level of solvent, the moderately lithiated UIO-66-BDC-(COOH)₂-pH7 showed the highest levels of lithium conductivity. Thus, specific impedance spectra for these samples was included for demonstrative purposes. FIG. 5 shows a typical base MOF powder sample (in this case UIO-66-BDC-(COOH)₂-pH7) after the pressure cell had been disassembled following the electrochemical impedance spectroscopy measurement. In FIG. 5, the base MOF powder is sintered into a pellet under pressure. The cell was pressured to 10 tons of pressure. FIG. 6 shows the electrochemical impedance spectrum of the sample shown in FIG. 5 with an equivalent circuit fit. The measurements shown in FIG. 6 were conducted in a pressure cell at 10 tons of pressure. The data fit is shown. The fit was obtained with the equivalent circuit shown in FIG. 11. This sample consistently showed the highest conductivity of the base MOF powders without the addition of a solvent molecule to the structure. FIG. 7 shows a pelletized UIO-66-BDC-(COOH)₂-pH7 soaked in moderate solvent condition. The MOF in FIG. 7 was soaked in an electrolyte solution of 1M LiClO₄ in propylene carbonate with a ratio of 10:1 [ml:g] of electrolyte solution to powder, sample pressed to 5 tons, and the pellet extracted from pellet press die for measurement when the pressure read out had relaxed to 3 tons. The corresponding impedance spectra for this sample is shown in FIG. 8. In FIG. 8, the data fit is shown and the fit was obtained using the equivalent circuit shown in FIG. 11. FIG. 9 shows a pelletized UIO-66-BDC-(COOH)₂-pH7 soaked in heavy solvent conditions. The MOF powder was soaked in an electrolyte solution of 1M LiClO₄ in propylene carbonate with a ratio of 20:1 [ml:g] of electrolyte solution to powder, sample pressed to 5 tons, and pellet extracted from pellet press die for measurement when the pressure read out had relaxed to 3 tons. The corresponding impedance spectra for this sample is shown in FIG. 10. In FIG. 10, the data fit is shown and the fit was obtained using the equivalent circuit shown in FIG. 11.

A coarse (300-500 nm compared to fine size at 30-50 nm) version of the UIO-66-BDC-(COOH)₂—Li₂SO₄-5 was subjected to the same soaking procedure as the other lithiated and control MOF samples. The hypothesis was that if the ionic conductivity improved with larger particle size, then the lithium-ion transfer is occurring primarily in the bulk of the MOF particle, rather than along the surface of the MOF. However, if the smaller particle MOFs showed higher ionic conductivity then lithium transfer along the surface of the MOF particles had a larger contribution to the total ionic conductivity of the material. As the results in Table 5 show, the larger particle MOF showed an ionic conductivity several orders of magnitude below the other MOF samples. While not wishing to be bound by theory, this suggests that the ionic conduction does not occur primarily through the bulk of the MOF particle.

A series of MOFs with a varying level of linkers was also subjected to the same soaking conditions as the initial MOF samples shown in Table 5. The results from analyzing the electrochemical impedance spectra for each of these materials are summarized in Table 6. The lithiation and bound-solvent treatment drastically improved the ionic conductivity of these samples as well. However, there does not seem to be a discernable trend between the degree of missing linker and the final overall ionic conductivity of the material, even though there is a trend in how much lithium can be inserted into the material depending on the percentage of linker missing in the material—the higher the percentage of linker missing from the material, the more lithium can be inserted into the MOF structure due to the increased number of defect sites. While not wishing to be bound by theory, this result implies that the lithiation on the —COOH linkers might take priority in effecting the Li⁺-ion conductivity in these materials over lithiating the —OH groups in the Zr₆-cluster or the defect sites within the MOF itself.

TABLE 6
Summary of ionic conductivity values obtained from equivalent circuit analysis
of all trials of electrochemical impedance spectroscopy measurements of bound-
solvent metal-organic frameworks with various levels of lithiation and linker
defects prepared with different amounts of solvent. Fields marked with “X”
designate samples with a resistance too large to measure with the experimental
set up used. Fields marked with “N/A” designate samples that could
not be prepared properly for the electrochemical impedance measurements.

| | UIO-66-BDC- | UIO-66-BDC- | UIO-66-BDC- | UIO-66-BDC- |
|---|---|---|---|---|
| | (COOH)₂ | (COOH)₂ | (COOH)₂ | (COOH)₂ |
| Sample □ | 40% Missing | 30% Missing | 20% Missing | 10% Missing |
| Solvent | Linker | Linker | Linker | Linker |
| Amount ↓ | [Li:Zr₆] = [9.4] | [Li:Zr₆] = [8.6] | [Li:Zr₆] = [8.0] | [Li:Zr₆] = [8.0] |
| No Solvent | 1.432 × 10⁻⁸ S/cm | X | X | X |
| Moderate | 2.62 × 10⁻⁵ S/cm | N/A | 1.86 × 10⁻⁵ S/cm | 3.58 × 10⁻⁵ S/cm |
| Solvent | | | | |
| mL:g [10:1] | | | | |
| High Solvent | N/A | 3.90 × 10⁻⁵ S/cm | 5.10 × 10⁻⁵ S/cm | 4.80 × 10⁻⁵ S/cm |
| mL:g [20:1] | | | | |

The present disclosure is not limited to Zr MOFs. To demonstrate that the methods taught herein also work for non-Zr MOFs, two aluminum (Al)-based MOFs were subjected to the same bound solvent treatment that the MOFs summarized in Table 5 underwent. The resulting ionic conductivity values for these Al-based MOFs after analyzing their impedance spectra with the equivalent circuit provided in FIG. 11 are provided in Table 7. These Al-MOFs did not have any ionic conductivity prior to the soaking procedure due to their lack of pre-lithiation. This differentiates these samples from all others presented in this disclosure. Nevertheless, the soaking procedure also yields high ionic conductivities for these MOFs.

TABLE 7
Summary of ionic conductivity values obtained from equivalent
circuit analysis of all trials of electrochemical impedance
spectroscopy measurements of bound-solvent metal-organic frameworks
with alternative MOF compositions. Fields marked with “—”
designate samples that did not have any Li⁺-ion conductivity.

| Sample □ | | |
|---|---|---|
| Solvent Amount ↓ | Al-MOF-MIL-68 | Al-MOF-CAU-10 |
| No Solvent | — | — |
| Moderate Solvent | 4.39 × 10⁻⁵ S/cm | 1.52 × 10⁻⁴ S/cm |
| mL:g [10:1] | | |
| High Solvent | 1.51 × 10⁻⁵ S/cm | 2.25 × 10⁻⁴ S/cm |
| mL:g [20:1] | | |

The results of the electrochemical impedance spectroscopy measurements show exceptional levels of ionic conductivity. The UiO-66-BDC-(COOH)₂-pH7 and UiO-66-BDC-(COOH)₂—Li₂SO₄-2 samples under heavy solvent conditions have ionic conductivity values above 1×10⁻³ S/cm. The UiO-66-BDC-(COOH)₂-pH7 samples under heavy solvent conditions were tested multiple times and verified to have the highest conductivity of all the samples tested with an average ionic conductivity of 1.55×10⁻³ S/cm over three trials. This ionic conductivity is the highest reported for any MOF based material.

### Methods for Obtaining High Lithium Loading in Metal Organic Framework Materials

During the lithiation, lithium is in oxidation state +1, meaning as Li⁺ ions. Therefore, these lithium species will compete with protons when reacting with MOF materials. MOF materials have acid/base properties and will interact with both Brønsted and Lewis acids. The coupling of an inorganic-cluster with linkers is typically an acid-base reaction. Carboxylate MOFs are used as an example, but the methods described are not limited to this specific class of MOF materials.

(Zr—O)n-OH+HOOC—R<->(Zr—O)—O₂—R (2)

This is a dynamic equilibrium that may be activated during the lithiation; thus, control of pH during the reaction can be important. The combined control of pH and lithium concentration is an aspect of our preferred lithiation methods. The combination of a high lithium-ion concentration with pH regulating compounds, for example, buffer systems, can both direct the lithium to the targeted sites in the MOF, as shown in FIG. 12, and prevent destruction of the MOF crystalline framework during the lithiation process.

A potential step of the lithiation process is the pre-determination of the pH range for the different lithiation sites. This can be achieved through potentiometric titrations with sodium hydroxide in water, which is a technique for determining the number of available sites for exchange with ions. FIG. 12 illustrates three different sites in the specific UIO-66-(COOH)₂ MOF with missing linkers used for demonstration purposes. The derivative of the thermogravimetric profile shows three distinct peaks, each of which correlates to a site which lithium can functionalize. Table 4 summarizes lithiation of the Zr-based MOF with six different lithium-boron buffer systems as described in Examples 1a-1c, described below.

TABLE 8
Favorable salts for lithiation of MOFs are shown. Combinations of acid and salts that will
form lithium bicarbonate, lithium carbonate, and lithium fluoride are not preferred.

| [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|
| Lithium acetate | LiC₂H₃O₂ | 31.2 | 35.1 | 40.8 | 50. [symbol] | 68.6 | | | | | | |
| Lithium azide | LiN₃ | 61.3 | 64.2 | 67.2 | 71.2 | 75.4 | | 86.6 | | | | 100 |
| Lithium benzoate | LiC [symbol] H₅O₂ | 38.9 | 41.6 | 44.7 | 53. [symbol] | | | | | | | |
| Lithium bicarbonate | LiHCO₃ | | | 5.74 | | | | | | | | |
| Lithium bromate | LiBrO₃ | 154 | 166 | 179 | 198 | 221 | | 26 [symbol] | | 308 | 329 | 355 |
| Lithium bromide | LiBr | 143 | 147 | 160 | 183 | 211 | | 223 | | 245 | | 266 |
| Lithium carbonate | Li₂CO₃ | 1.54 | 1.43 | 1.33 | 1.26 | 1.17 | | 1.01 | | 0.85 | | 0.72 |
| Lithium chlorate | LiClO₃ | 241 | 283 | 372 | 488 | [symbol] 04 | | 777 | | | | |
| Lithium chloride | LiCl | 6 [symbol] .2 | 74.5 | 83.5 | 86.2 | 89.8 | | 98.4 | | 112 | 121 | 128 |
| Lithium chromate | Li₂CrO₄•2H₂O | | | 142 | | | | | | | | |
| Lithium dichromate | Li₂Cr₂O [symbol] •2H₂O | | | | 151 | | | | | | | |
| Lithium dihydrogen phosphate | LiH₂PO₄ | 126 | | | | | | | | | | |
| Lithium fluoride | LiF | | | 0.16 | | | | | | | | |
| Lithium fluorosilicate | Li₂SiF₆•2H₂O | | | 73 | | | | | | | | |
| Lithium formate | LiHCO₂ | 32.3 | 35.7 | 39.3 | 44.1 | 49.5 | | 64.7 | | 92.7 | 116 | 138 |
| Lithium hydrogen phosphite | Li₂HPO₃ | 4.43 | | | 9.97 | 7.61 | | 7.11 | | | | 6.03 |
| Lithium hydroxide | LiOH | 11.9 | 12.1 | 12.3 | | 12.7 | | 13.2 | 14.6 | 16.6 | 17.8 | 19.1 |
| Lithium iodide | LiI | 151 | 157 | 165 | 171 | 179 | | 202 | | 435 | 440 | 481 |
| Lithium molybdate | Li₂MoO₄ | 82.6 | | 79.5 | 79.5 | 78 | | | | | | 73.9 |
| Lithium nitrate | LiNO₃ | 53.4 | 60.8 | 70.1 | 138 | 152 | | 175 | | | | |
| Lithium nitrite | LiNO₂ | 70.9 | 82.5 | 96.8 | 114 | 133 | | 177 | | 233 | 272 | 324 |
| Lithium oxalate | Li₂C₂O₄ | | | 8 | | | | | | | | |
| Lithium perchlorate | LiClO₄ | 42.7 | 49 | 56.1 | 63.6 | 72.3 | | 92.3 | | 128 | 151 | |
| Lithium permanganate | LiMnO₄ | | | 71.4 | | | | | | | | |
| Lithium phosphate | Li₃PO₄ | | | 0.03821 | | | | | | | | |
| Lithium selenide | Li₂Se | | | 57.7 | | | | | | | | |
| Lithium selenite | Li₂SeO₃ | 25 | 23.3 | 21.5 | 19.6 | 17.9 | | 14.7 | | 11.9 | 11.1 | 9. [symbol] |
| Lithium sulfate | Li₂SO₄ | 36.1 | 35.5 | 34.8 | 34.2 | 33.7 | | 32.6 | | 31.4 | 30.9 | |
| Lithium tartrate | Li₂O₄H₄O₆ | 42 | 31.8 | 27.1 | 26.6 | 27.2 | | 29.5 | | | | |
| Lithium thiocyanate | LiSCN | | | 114 | 131 | 153 | | | | | | |
| Lithium vanadate | LiVO₃ | 2.5 | | 4.82 | 6.28 | 4.38 | | 2.67 | | | | |

[symbol]

indicates data missing or illegible when filed

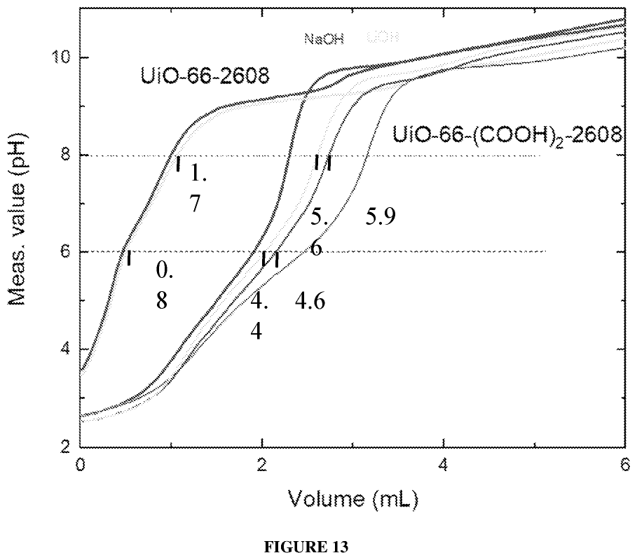

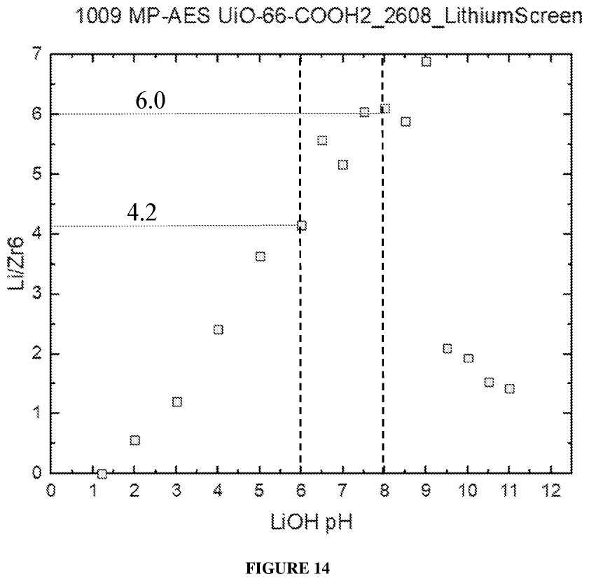

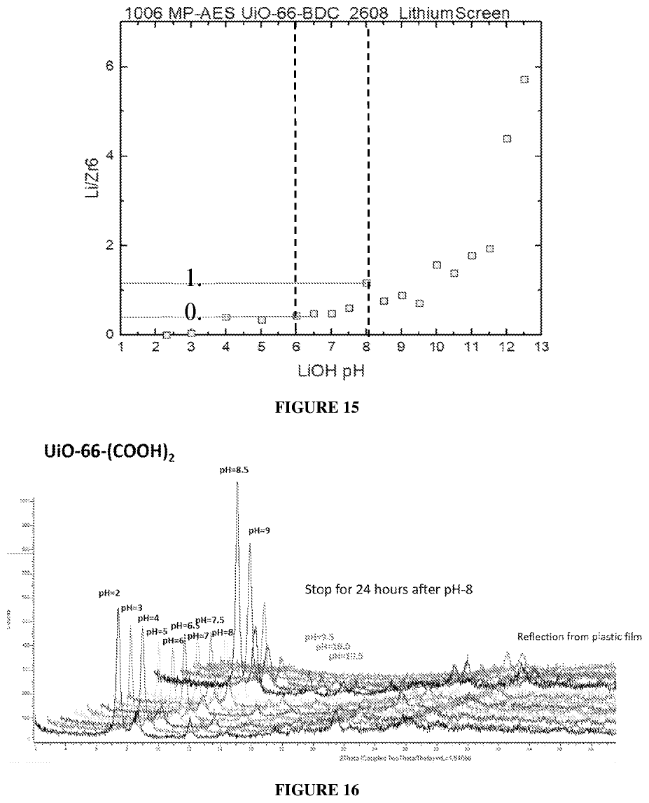

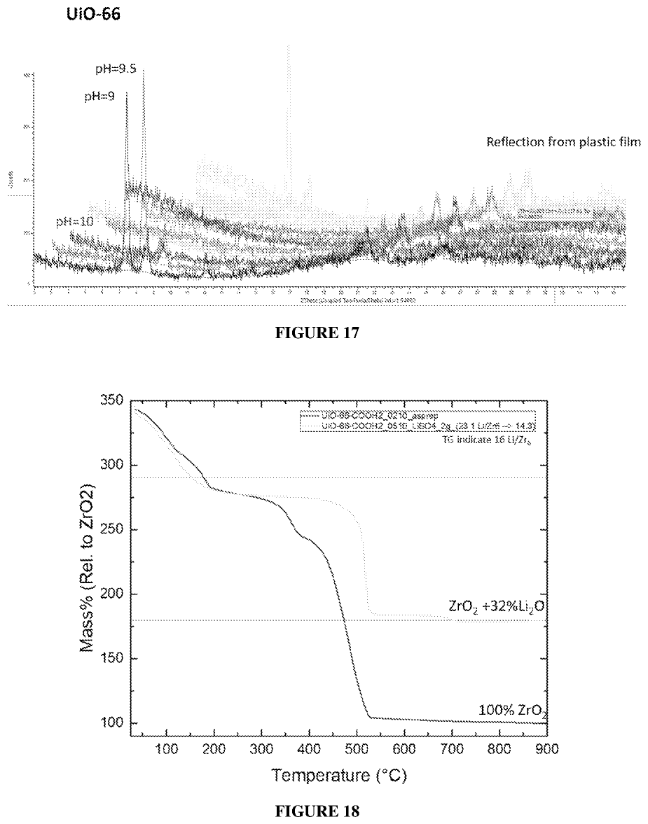

This disclosure is not limited to a boric acid/lithium borate buffer, as shown in Examples 1a-1c. Several parameters are preferably within optimal ranges at the same time to obtain highest degrees of lithiation. The titration experiments shown in FIG. 13 reveal that the pH is preferably as high as possible to obtain high lithiation, but not so high that the crystalline structure of the MOF is destroyed. FIGS. 14 and 15 summarize the degrees of lithiation when titrated to various pH levels for the UiO-66-(COOH), and UiO-66-BDC MOFs, respectively. FIG. 16 shows powder X-ray diffraction patterns for the UiO-66-(COOH)₂ MOF after being titrated to various pH levels to lithiate the structure. FIG. 17 shows the same data for the UiO-66-BDC MOF. A pH of from 7-10, preferably from 8-9 is appropriate for the Zr-MOFs to obtain high lithiation while maintaining the crystalline framework of the MOF. Boric acid and phosphoric acid have good pKa values (for example, at least 5), while acetic acid and sulfuric acid have low pKa values. Only the most acidic protons will then be replaced by lithium.

To improve lithiation and bound solvent uptake, combinations of acid and salt that form lithium compounds with low solubility should be avoided. For example, lithium phosphates that have a very low insolubility in water should be avoided. With this combination lithium will typically be lost as precipitate and thus will not participate in the MOF lithiation process. Table 8 provides a guideline for selection of favorable salts for this lithiation procedure. Lithium carbonate, lithium bicarbonate, and lithium fluoride are not preferable for application with Zr-MOFs.

H⁺ and Li⁺ ions compete for the locations next to negative charge in the MOF during the lithiation process. This consideration entails that the concentration of H⁺ be reduced during the lithiation procedure, which is achieved by regulating pH and increasing the concentration of Li⁺ in the solution. Suitable concentrations of Li+ are from for example, from 1×10⁻⁶ M to 10 M, from 0.001M to 5M, or from 0.1M to 2M, in terms of Li-salt concentration in the buffer solution. Although using LiOH as a salt in the solution for lithiation yields a small degree of lithiation, an option to enhance the concentration of Li+ to achieve higher degrees of lithiation is to add additional lithium salt in conjunction with LiOH. The results shown in Table 9 illustrate this approach. Table 10 shows lithiation results for UiO-66-(COOH)₂ with various lithium salts and buffer solutions. There is a trend that the higher the concentration of Li⁺ in the solution during the lithiation procedure, the higher the degree of lithiation in the final MOF material.

TABLE 9
The same Zr-MOF lithiated with six different lithium-boron buffer systems.

Boric Acid (H₃BO₃) 1M + LiOH 0.25M + LiCl 0.75M pH = 7.6 Li/Zr₆ = 15.5
Boric Acid (H₃BO₃) 1M + LiOH 0.50M + LiCl 0.50M pH = 9.2 Li/Zr₆ = 8.0
Boric Acid (H₃BO₃) 1M + LiOH 0.25M + LiNO₃ 0.75M pH = 7.6 Li/Zr₆ = 19.2
Boric Acid (H₃BO₃) 1M + LiOH 0.50M + LiNO₃ 0.50M pH = 9.2 Li/Zr₆ = 8.2
Boric Acid (H₃BO₃) 1M + LiOH 0.25M + LiSO₄ 0.75M pH = 7.6 Li/Zr₆ = 17.4
Boric Acid (H₃BO₃) 1M + LiOH 0.50M + LiSO₄ 0.50M pH = 9.2 Li/Zr₆ = 15.6

TABLE 10
Summary of results of lithiation with various lithium salts and
buffer solutions. These samples were soaked in a lithium solution
at room temperature overnight. The lithium concentration was 10 times
that of the expected theoretical lithiation capacity for UiO-66-(COOH)₂
(16 Li/Zr₆-cluster). Samples were centrifuged and liquid
removed with vacuum suction before being dried at 150° C.

| | | Li + | Li + | Li + | Li + |
|---|---|---|---|---|---|
| Lithiation with | Buffer Solutions | 0.15M | 0.3M | 0.45M | 0.6M |
| LiOH | Acetic Acid 0.3M | 1.7 | 2.79 | 5.47 | 7.76 |
| LiAcetate | Acetic Acid 0.3M | 2.07 | 2.96 | 4.91 | 7.14 |
| LiOH | Boric Acid 0.3M | 4.54 | 7.78 | 12.66 | 18.43 |
| LiAcetate | Boric Acid 0.3M | 3.17 | 3.93 | 5.78 | 8.99 |
| NaOH + LiOH | Boric Acid 0.3M | 4.14 | N/A | N/A | N/A |
| LiOH | Acetic Acid 0.3M | 6 | 4.87 | 9.14 | 10.32 |
| LiAcetate | Acetic Acid 0.3M | N/A | N/A | N/A | N/A |
| LiOH | Boric Acid 0.3M | 11.5 | 7.5 | 10.18 | 18.17 |
| LiAcetate | Boric Acid 0.3M | 7.41 | 10.84 | 11.84 | 27.37 |

After the lithiation all samples were analyzed with energy dispersive X-ray spectroscopy (EDS) in addition to the MP-AES. With the EDS technique, all elements above Be (Atomic No. 4) can be detected. Thus, lithium (Atomic No. 3) cannot be detected with EDS, only with atomic emission spectroscopy. EDS analysis allowed for the possibility, that the increased lithium content is due to trapped lithium salts in the porous MOF material, to be ruled out. Trapped salt would have been detected by Cl, N or S signal from the salt anions; however, none of these elements were detected. Thus, using the teachings herein, the lithium content in these MOF materials can be increased 3.4-4 times compared to previous methods described in the literature. Specifically, lithium content in the lithiated MOFs can be from about 1 to 50, for example as measured by atomic emission spectroscopy. FIG. 18 shows thermogravimetric curves of the UIO-66-(COOH)₂ sample with the highest lithium content before and after the lithiation procedure. The change in weight loss for the lithiated and non-lithiated sample was used to quantify the amount of lithium in each sample after the lithiation procedure. The results were checked against atomic emission spectroscopy of the same samples and found to be in good agreement that, for the sample shown in FIG. 18, the lithium uptake was 14.3 Li:Zr₆. The weight changes when the MOF decomposes are much smaller for the lithiated material. This change in weight loss can be used for a quantification of the lithium content. The magenta curve is scaled assuming 16 lithium ions per Zr₆ cluster. This results in a perfect fit with the non-lithiated MOF and agrees with the atomic emission analysis.

### D. Battery Applications

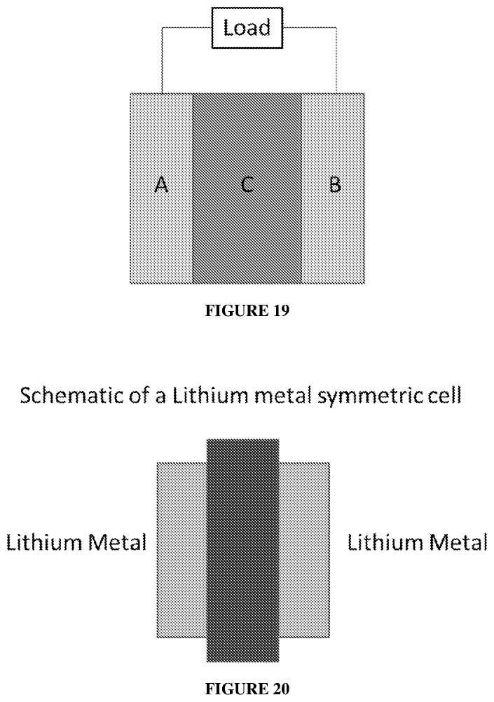

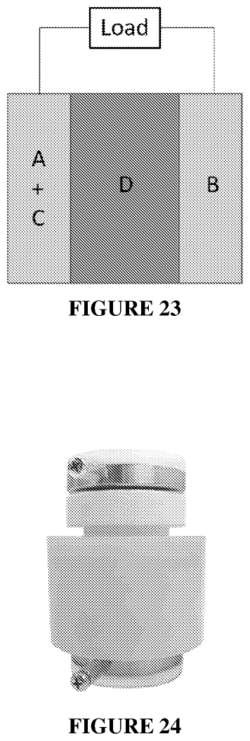

With the surprising levels of ionic conductivity achieved in this disclosure, lithium containing MOFs with a bound solvent can serve at least three distinct purposes in a secondary battery. A noteworthy aspect of this disclosure is that the defect sites of the MOF structure are partially occupied by lithium ions added during the lithiation procedure that allows much higher lithiation levels in these materials than previously reported, and the remaining defect sites occupied by bound solvent/salt molecules from an electrolyte solution. These materials can function as a stand-alone solid-state electrolyte or a component of a composite solid-state electrolyte as shown in FIG. 19, as an electrode buffer layer between the electrode(s) and electrolyte as shown in FIG. 22 or as an electrode active material/electrode composite additive as shown in FIG. 23.

### E. Solid-State Electrolyte

A typical secondary battery uses an organic-solvent liquid electrolyte with a porous separating media between two solid electrode composites. A solid-state battery replaces the liquid electrolyte and porous separator with a solid electrolyte that serves to physically separate the electrode while also allowing for the diffusion of working cations.

Lithiated bound solvent MOFs can serve as a stand-alone solid-state electrolyte between the two electrodes of a secondary battery as shown in FIG. 19. Components A and B are solid electrode composites. One represents the cathode and the other represents the anode. Component C represents a solid electrolyte which can be comprised of a single material or a composite of multiple components. During discharge, the load represents a device being powered by the battery (sink) as the working ions are moving from the anode to the cathode within the battery. During charge, the load represents a source that is providing energy to the battery to move working ions from the cathode to the anode. The electrodes can be either liquid or solid. In this application, the MOF can serve the function of separating the two electrochemically active electrode species of the cell while also conducting the working ions from one electrode to the other during operation. Ionic conduction can occur directly through the bulk of the MOF or along the surface of a MOF particle. In another embodiment, lithiated bound solvent MOFs can serve as a component within a composite, which serves as a solid electrode between the two electrodes of a secondary battery, as shown in FIG. 19. Similarly, the electrodes may be liquid or solid. In this instance, the bound solvent MOF can be an additive component within an overall composite where the separation of the two electrodes is predominantly due to a structural composite backbone to which the MOFs add additional mechanical integrity. The MOFs can also assist in the conduction of working ions. The lithiated MOFs with a bound solvent may be the dominant or only means of ionic conduction in the electrolyte if the structural backbone of the composite in which they are housed is either not ionically conductive or has low ionic conductivity. Ionic conduction can again occur directly through the bulk of the MOF or along the surface of a MOF particle.

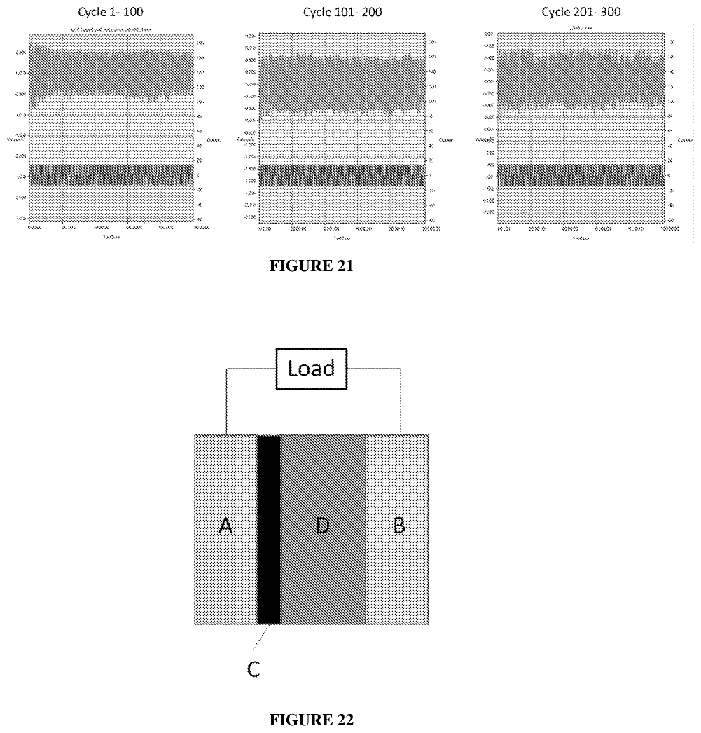

FIG. 20 shows a specialized version of a solid-state cell in which component A and B from FIG. 19 are both composed of lithium metal—known as a lithium metal symmetric cell. To demonstrate the stability of the bound-solvent lithiated MOFs against lithium metal, which is a strong reducing agent, a symmetric lithium metal cell was prepared with an electrolyte pellet serving as component C in FIG. 19 that was solely composed of UIO-66-(COOH)₂ MOF that was prelithiated to a pH of 7 before being soaked in a solution of 1M LiClO₄ in propylene carbonate. A symmetric cell is cycled by running an electronic current across an external circuit and letting Li⁺ diffuse through the solid electrolyte and plate at the appropriate lithium metal electrode. The mechanical and electrochemical stability of the solid electrolyte can be gleaned from the observation of the voltage of the symmetric cell during constant current cycling. FIG. 21 shows the results of this experiment for a pellet of MOF treated with the lithiation and bound solvent approach described herein. The MOF is UIO-66-(COOH)₂ that was lithiated in an aqueous solution with an LiOH buffer until the pH of the mixture reached 7. Then, after washing the MOF of residual LiOH and drying in a vacuum furnace, the MOF was soaked in a solution of 1M LiClO₄ in propylene carbonate for 24 hours. Finally, the MOF was filtered from the solution and pressed into a dense pellet that was 13 mm in diameter and assembled into a lithium metal symmetric cell. The cell was cycled at a current density of 25 μA normalized to the cross-sectional area of the lithium metal electrodes. The steady voltage values at each electrode during the charge and discharge cycle demonstrate the mechanical and electrochemical stability of this lithiated bound solvent MOF pellet against lithium metal.

### F. Electrode Buffer Layer

In another embodiment, lithiated MOFs with a bound solvent as described herein, can be used in secondary batteries as an electrode buffer layer between the electrode and the electrolyte, for example, as shown in FIG. 22. Components A and B are solid electrode composites. One represents the cathode and the other represents the anode. Component C represents a buffer layer between solid electrode composite A and the electrolyte component D. Component D represents an ionically conducting component that is electronically insulating. Component D can be a single component, such as a solid-state electrolyte, a composite of several components, or a combination of components, for example, a polymer separator and a liquid electrolyte. Lithiated MOFs with a bound solvent also can be used in situations when the electrode is not chemically, electrochemically, or mechanically stable against the electrolyte during electrochemical operation or assembly. The electrolyte may be solid or liquid. When this occurs, buffer layers that are stable against both the electrode and the electrolyte can serve to mitigate the parasitic reactions and maintain a stable working interface during cycling of the battery. Lithiated MOFs for this use can have redox centers or non-redox active metal nodes. Lithated MOFs can serve as a stand-alone buffer or as a part of a composite with a structural backbone that serves as a buffer layer.

### G. Electrode Materials or Electrode Additive Materials

In another embodiment, lithiated bound solvent MOFs with a component, for example, iron, cobalt, manganese, or nickel, that can be electrochemically oxidized or reduced can serve as an electrode active material, with the lithium within the MOF serving as the lithium source for the cell's electrochemical operation as shown in FIG. 23. In FIG. 23, Component A (electrode composite) has an additive that assists in the electrochemical operation of the cell. Additives can be added to assist with several different functions, but in the case of the bound-solvent MOFs described herein, the additive serves to provide selective ionic conduction within the composite. Components B and D are the same as in FIG. 22. Thus, the opposing electrode active material to be used in conjunction with a lithiated MOF active material does not need to be assembled in a lithiated state, such as, for example, graphitic carbon. These batteries can use either a solid or a liquid electrolyte.

In another embodiment, lithiated bound solvent MOFs with or without a redox active component, for example, iron, cobalt, manganese, or nickel, that can serve as an additive component to an electrode composite for a secondary battery as shown in FIG. 23. As an additive, lithiated bound solvent MOFs can serve to increase the capacity of the cell as well as to provide an additional lithium source to aid in mitigating the fade in capacity due to lithium losses from parasitic reactions that may occur during cycling. Additionally, lithiated MOFs can serve as a molecular sieve for selective diffusion of mobile species upon charge/discharge cycling, such as in lithium-sulfur batteries.

### EXAMPLES

### Material Preparation

### Example 1—Lithium Borate Buffer

Preparation of a pH=8.2 lithiation buffer: 6.183 g Boric Acid (H₃BO₃) is dissolved in 80 ml H₂O. When dissolved 1.1 g LiOHx1H₂O added, when dissolved H₂O added until the total volume is 0.1 liter.

Preparation of a pH=9.5 lithiation buffer: 6.183 g Boric Acid (H₃BO₃) is dissolved in 80 ml H₂O. When dissolved 2.1 g LiOHx1H₂O added, when dissolved H₂O added until the total volume is 0.1 liter.

### Example 1a. Boosting Lithium Concentration with Lithium Chloride

Before the last dilution as described in the procedure above 3.18 g of LiCl is added.

### Example 1b. Boosting Lithium Concentration with Lithium Nitrate

Before the last dilution as described in the procedure above 5.17 g of LiNO₃ is added.

### Example 1c. Boosting Lithium Concentration with Lithium Sulfate

Before the last dilution as described in the procedure above 8.24 g of Li₂SO₄ is added.

Lithiation of Zr-MOF UiO-66-(COOH), (Lot CA2608) with a Series of Lithium Salt-Solutions

The MOF was soaked in the lithium solution overnight at room temperature. The lithium solutions that the MOF was soaked in contained a 10-times surplus of lithium relative to the theoretical maximum adsorption sites. After lithiation the samples were centrifuged to collect the lithiated MOF powder. The MOF was then centrifuged with water to remove any residual lithium salt and wash the lithiated MOF sample. After this washing procedure, the lithiated MOF was dried at 150° C. to remove any remaining water. For lithium quantification, the solid lithiated MOF samples were dissolved in a NaOH solution, diluted 1000 times before the zirconium and lithium content were analyzed with an Agilent Technologies 4100 MP-AES analyzer. The Li/Zr₆ ratio is reported in the results section instead of the absolute lithium value to eliminate uncertainty in the amount of MOF that was analyzed.

### Binding Solvent to Lithiated Metal Organic Frameworks

Once the MOF had been lithiated, solvent was bound to the MOF through a soaking and filtration process. The lithiated MOF was soaked in an electrolyte solution of 1M LiClO₄ in propylene carbonate (PC) for 24 hours. After the soaking process, the mixture of MOF in electrolyte was vacuum filtered and washed with additional propylene carbonate to remove any residual electrolyte solution. Once the bound solvent lithiated MOF powder was obtained from the lithiation process, it was dried in a vacuum desiccator for 72 hours before being pressed into pellets for electrochemical impedance spectroscopy measurements.

Measuring Ionic Conductivity of Lithiated Metal Organic Framework with a Bound Solvent

### Sample Preparation

### 1. Lithiated MOF Powders

Base lithiated MOF powders without bound solvent were prepped for electrochemical impedance spectroscopy measurements with a pressure cell, shown in FIG. 24. This allowed for the pellet to be formed and measured without extraction from the cell. The cell was pressed to 10 tons of pressure. External pressure was removed from the cell after the pressure readout had relaxed to 6 tons. The cell was then used to conduct electrochemical impedance spectroscopy measurements without additional pressure during the measurement. The diameter of the pressure cell cavity where the sample was formed in-situ is 15 mm.

2. Lithiated MOF Powders with a Bound Solvent

Lithiated bound solvent MOF samples were prepared for electrochemical impedance spectroscopy measurements to determine their ionic conductivity by pelletization with a laboratory press and die. These pellets were pressed with a 13 mm die to 5 tons of pressure. The pressure was relieved, and the pellet extracted when the pressure readout on the press read 3 tons of pressure. In addition to pelletizing the sample for measurement, the pressing process removed any residual solvent that was not removed during the vacuum drying process.

### Electrochemical Impedance Spectroscopy

Electrochemical impedance spectroscopy was performed on an Autolab potentiostat with the alternating current impedance method. The samples were scanned from the frequency of 1×10⁶ Hz to 0.1 Hz with a perturbation voltage ranging from 10-100 mV. Stainless steel electrodes were used to form a symmetric cell with each pelletized sample for the bound solvent lithiated MOFs. For the base lithiated MOF powders, the two stainless steel pistons of the pressure cell served as the electrodes to form a symmetric cell for the impedance measurements. All electrochemical impedance spectra were collected at room temperature.

### Interpretation of Electrochemical Impedance Spectroscopy Results

The obtained electrochemical impedance spectra described herein were interpreted according to an equivalent circuit analysis. A third-party software program (ZView) was used with the equivalent circuit shown in FIG. 11 to fit the impedance spectra. The circuit element R₂ represents the ionic resistance of the sample being measured. Once the value of R₂ is obtained from the equivalent circuit fitting procedure, it can be plugged into eq. (1) along with sample thickness 1 and cross-sectional area A to obtain the ionic conductivity in units of S cm⁻¹.

σ=(1*R)/A (1)

All ionic conductivities reported herein were calculated with this formalism.

1. A composition comprising a metal organic framework (MOF) structure comprising a plurality of defect sites comprising one or more of lithium, sodium, or potassium providing a MOF degree of lithiation, sodiation, or potassiation in a range of 1 to 50 lithium, sodium, or potassium ions per unit formula of MOF.

2. The composition of claim 1, wherein the metal organic framework comprises a Zr-metal organic framework.

3. The composition of claim 1, wherein the plurality of defect sites comprise lithium and the degree of lithiation is from 1 to 50.

4. A composition comprising: a metal organic framework structure comprising defect sites and open structural sites comprising lithium ions and solvent molecules providing a MOF degree of lithiation of from 1 to 50.

5. The composition of claim 4, wherein the metal organic framework comprises a Zr-metal organic framework.

6. The composition of claim 4, wherein the plurality of defect sites comprise lithium and the degree of lithiation is from 1 to 50.

7. The composition of claim 4, wherein the metal organic framework has a lithium conductivity in the range of 1×10⁻⁸ to 0.05 S/cm.

8. (canceled)

9. A composition comprising: a metal organic framework structure comprising defect sites and open structural sites comprising lithium ions and solvent molecules providing a MOF degree of lithiation of from 1 to 50.

10. The composition of claim 9, wherein the metal organic framework comprises a Zr-metal organic framework.

11. The composition of claim 9, wherein the metal organic framework comprises a non-Zr-metal organic framework.

12.-13. (canceled)

14. A method of lithiating a metal organic framework comprising:
(A) contacting a metal organic framework with a lithiation buffer comprising a lithium containing compound and a buffer to lithiate the metal organic framework;
(B) washing the lithitated metal organic framework to remove residual lithium; and
(C) drying the lithiated metal organic framework.

15. The method of claim 14, wherein the pH of the lithiation buffer is from 7 to 10.

16. The method of claim 14, further comprising adding a second lithium containing compound to the lithiation buffer prior to contacting the lithiation buffer and the metal organic framework structure.

17. (canceled)

18. The method of claim 14 further comprising adjusting the pH of the lithiation buffer before contacting the lithiation buffer and the metal organic framework structure.

19. The method of claim 14, wherein the lithitation buffer has a pKa value of at least 5.

20. The method of claim 14, wherein the metal organic framework comprises a Zr-metal organic framework.

21. (canceled)

22. The method of claim 14, wherein the lithiation solution comprises at least ten times more lithium than a theoretical maximum number of adsorption sites in the metal organic framework.

23. The method of claim 14, wherein the lithitation buffer comprises at least one of boric acid and phosphoric acid.

24.-26. (canceled)

27. A battery comprising:
(A) a cathode;
(B) an anode; and
(C) the composition of claim 1, wherein the composition functions as one of a solid electrolyte, a buffer layer between the cathode and anode, or an additive to one or the cathode or anode.

28. A battery comprising:
(A) a cathode;
(B) an anode; and
(C) the composition of claim 4, wherein the composition functions as one of a solid electrolyte, a buffer layer between the cathode and anode, or an additive to one or the cathode or anode.
